(19) United States
(12) Patent Application Publication
(10) Pub. No.: US 2010/0253177 A1
(43) Pub. Date: Oct. 7, 2010

(54) Multi-pattern high temperature superconducting motor using flux trapping and concentration

(76) Inventors: Philippe Masson, Tallahassee, FL (US); Cesar Luongo, Tallahassee, FL (US)

Correspondence Address: NORRIS, BRADEN, MELTON & GREGERSEN, PLLC;Suite 305, 1901 Pennsylvania Avenue, N.W., Washington, DC, 20006, US

(21) Appl. No.: 12/453,549

(22) Filed: May 14, 2009

Related U.S. Application Data
(62) Division of application No. 11/256,303, filed on Oct. 24, 2005.
(60) Provisional application No. 60/714,355, filed on Sep. 7, 2005.

(51) Int. Cl. H02K 1/06; H02K 55/02

(52) U.S. Cl. 310/216.106; 505/166

(57) ABSTRACT

A high temperature superconducting synchronous motor having an inductor topology that increases the air gap flux density in direct relation to motor power density by trapping flux and concentrating it in the air gap to obtain more power in the same volume or smaller volume for the same power, and whose geometry enables the induction motor to be lighter than superconducting motors without the inductor topology, the motor being positioned in a housing, and the motor comprising:
a) stator means having an armature winding to provide a stator field;
c) rotor means positioned within the stator field and on which is disposed at least two polygon shaped ring or coil means along the same axis to provide separated and spaced apart relationship field solenoids;
c) at least four high temperature superconducting plate means disposed in alternating relationship between the ring or coil means to hold the ring or coil means together to trap magnetic field and shape flux lines; and
d) cooling means to cool the superconducting in the rotor to a temperature below the critical temperature of the superconducting plate means.

The present invention relates to use of non-conventional topology for a superconducting inductor used in a synchronous machine utilizing the unique capability of high temperature superconductors to trap a magnetic field and is a divisional application to application Ser. No. 11/256,303 filed Oct. 24, 2005, and claims the benefit of the Sep. 7, 2005 filing date of provisional application No. 60/714,355.

### FIELD OF THE INVENTION

Use of this non-conventional topology coupled to field coils provides a high magnetic field that results in a substantial increase in the power density and the design is useful as an aircraft propulsion system.

### BACKGROUND OF THE INVENTION

### The Prior Art

High temperature superconductors permit a design of compact and lightweight electrical motors due to their very high current density and negligible DC losses. And, in general, superconducting technology is used for applications requiring high torque at low speed. However, for mobile systems, the reduction of toxic emission is paramount and electrical energy represents a good solution when generated by fuel cells. As a consequence, electrical power needs to be converted into mechanical power through electrical motors, even for low power levels. Nevertheless, conventional machines exhibit very low power densities in the range of 1 kW/kg and are therefore too heavy for most mobile applications.

U.S. Pat. No. 5,777,420 discloses a rotor construction for an electric motor in which high-permeability magnetic material is positioned with respect to a superconducting winding to reduce the reluctance of the flux path produced by the superconducting winding. In FIGS. 1-3 therein, a rotor assembly 10 for a synchronous motor having a four-pole topology is shown without its outer shield which encloses the vacuum layer within the overall assembly. The rotor assembly includes a torque tube 20 fabricated from a high-strength, ductile and non-magnetic material (e.g., stainless steel). The rotor assembly used within the superconducting electric motor includes a superconducting winding which is formed of high temperature superconductor and, during operation, generates a flux path within the rotor assembly; and a high permeability magnetic material, positioned within at least a portion of the flux path so as to decrease the overall reluctance of the flux path generated by the superconducting winding.

A cryogenic power conditioning system for fuel cells which is cooled by liquid hydrogen or liquid natural gas (methane) and used to power these fuel cells, or by liquid nitrogen supplied by high-temperature superconducting cables is disclosed in U.S. Pat. No. 6,798,083. The main applications are in large vehicles such as transit buses. The result is a combined motor and motor-drive system exhibiting higher efficiency, lower weight, smaller size and lower cost.

U.S. Pat. No. 6,597,082 discloses a superconducting rotating machine having a compact design, while still providing a relatively high output power. The superconducting machine is of the type having a stator assembly and a rotor assembly that rotates within the stator assembly and is spaced from the stator assembly by a gap. This arrangement can be used to produce a superconducting motor or generator. It has at least one HTS superconducting winding assembly which generates a magnetic flux linking the stator assembly and rotor assembly, a refrigeration system for cooling the at least one superconducting winding of the rotor assembly and the superconducting rotating machine has a torque density of approximately 75 Nm/Kg or more at 500 RPM or less, the torque density being equal to the motor shaft torque divided by the motor mass. The high torque density at low speeds is advantageous in situations where a high-speed motor would require a gearbox to reduce output speed. This design eliminates the need for gearboxes and can drive a ship propeller without use of a typical gearbox and saves space and reduces noise. FIGS. 1 and 2 therein show a superconducting synchronous motor 10, which includes a rotor assembly 50 cooled by a cryogenic cooling system 100, here a Gifford McMahon (GM) cooling system, surrounded by a stator assembly 20. Both the stator assembly 20 and the rotor assembly 50 are mounted in a housing 12 to protect the components and any users of the superconducting motor 10.

A superconducting motor that operates as a squirrel cage induction motor is disclosed in U.S. Pat. No. 6,791,229. The rotor is covered with a thin film of superconducting material and the magnetic field created by the stator is strong enough to quench the superconducting material to its normal state at periodic spots on the rotor. This periodic quenching both creates a squirrel cage configuration of superconducting material on the rotor and allows the stator field to penetrate the rotor to induce a current. Once the squirrel cage is “created” by the stator field and a current induced, the motor operates as a conventional squirrel cage induction motor.

FIG. 1 is an electric motor 10 connected via a shaft 14 to a machine 16 to which the motor 10 provides mechanical power. The shaft 14 penetrates, at one or both ends, a rectangular housing 12 that forms the outer portion of the motor 10. External to the housing 12 are a power source 24 to supply an AC current through a set of wires 22 that penetrate the housing 12 to connect to a stator (shown in FIG. 2), and a cooler 18 to supply a coolant (not shown) through a tube 20 that penetrates the housing 12.

U.S. Pat. No. 6,815,860 discloses a coil support system developed for a racetrack shape, high temperature super-conducting (HTS) coil winding for a two-pole rotor of an electrical machine. The coil support system prevents damage to the coil winding during rotor operation, supports the coil winding with respect to centrifugal and other forces, and provides a protective shield for the coil winding. The coil support system holds the coil winding with respect to the rotor. The HTS coil winding and coil support system are at cryogenic temperature while the rotor is at ambient temperature. FIG. 1 shows an exemplary synchronous generator machine 10 having a stator 12 and a rotor 14. The rotor includes field winding coils that fit inside the cylindrical rotor vacuum cavity 16 of the stator. The rotor fits inside the rotor vacuum cavity of the stator. As the rotor turns within the stator, a magnetic field 18 (illustrated by dotted lines) generated by the rotor and rotor coils moves/rotates through the stator and creates an electrical current in the windings of the stator coils 19. This current is output by the generator as electrical power. The rotor 14 supports at least one longitudinally-extending, racetrack-shaped, high-temperature super-conducting (HTS) coil winding 34 (See FIG. 2). The FITS coil winding may be alternatively a saddle-shape or have some other shape that is suitable for a particular HTS rotor design. A coil support system is disclosed here for a racetrack SC coil winding. The coil support system may be adapted for coil configurations other than a racetrack coil mounted on a solid rotor core.

“HTS Motor Technology & YBCO Specification”/Wire Development Workshop to Greg Snitchler (Jan. 21, 2003) discloses a multiphase synchronous air core machine with HTS in DC rotor field which is vacuum insulated.

A factory-tested AC synchronous HTS motor, integrated with a commercially available power electronic drive system that is said to be suitable for shipboard at-sea trials is disclosed in American Superconductors, March 2003 (Ship Propulsion 5 MW HTS Motor). The 5 MW rotor operates at 230 revolutions per minute (rpm). The low-speed, high-torque 5 MW HTS motor is a critical development milestone on the path to 25 MW and 36 MW motors, which are the power ratings expected to be utilized on electric warships and on large cruise and cargo ships. HTS motors of these power ratings are expected to be as little as one-fifth the volume of conventional motors.

### Superconductivity Web21 (Jul. 15, 2004) Published by International Superconductivity Technology Center

Title: Technology Development of Superconducting Rotating Machines—Progress of High-Temperature Superconducting Motor Technology (Page 23-24) by Tsutomu Hoshino, Kyoto University—disclose high-temperature superconducting motors for use in ship propulsion. FIG. 1 shows the development capacity transition of field winding superconducting synchronous motors in the U.S. FIG. 2 shows a radial-type armature and rotor.

There is a need to provide superconducting motors in which the air gap flux density is improved since the motor power density is proportional to the air gap flux density. There is a further need to achieve more power in the same volume or smaller volume, for the same power in superconductivity motors.

### SUMMARY OF THE INVENTION

One object of the present invention is to provide a part of a superconducting motor to increase the air gap flux density.

Another object of the present invention is to provide a part of a superconducting motor that gives more motor power density, since the motor power density is proportional to the air gap flux density.

A yet further object of the present invention is to provide a part of a superconducting motor that enables achievement of flux trapping and concentration in the air gap.

A still further object of the invention is to provide a part of a superconducting motor which enables achievement of more power in the same volume or smaller volume for the same power, wherein the configuration of the part of the superconducting motor enables the motor to be lighter.

These and other objects of the invention will become apparent by reference to the brief description of the drawings and detailed description of the preferred embodiment of the invention.

### BRIEF DESCRIPTION OF THE DRAWINGS

FIG. 1A shows an infinite superconducting plate subjected to a longitudinal magnetic field in which currents develop in response to the increase of applied field.

FIG. 1B shows the magnetic field profile in the plate.

FIG. 2 shows the three steps in zero field cooling by a superconducting plate when superconducting material remains in Meissner state.

FIG. 3 shows an external applied field profile for zero field cooling leading to effective shielding

FIGS. 4A, 4B, 4C, and 4D show for a shielding operation. Bₘₐₓ has to be lower than Bₛₐₜ, and, the larger the difference, the better the shielding, as Bean's model for a zero field cooling.

FIG. 5 shows that after a field cooling, a superconducting plate behaves like a permanent magnet, as shown in the three steps.

FIG. 6 shows the applied field profile when one considers an applied magnetic flux after the superconducting plate has been under Bₘₐₓ.

FIGS. 7A, 7B, 7C, and 7D shows that a large part of the flux has been trapped for the critical state model for field cooling.

FIG. 8 shows the magnetic field pulse in the applied field profile where the peak value has to exceed the saturation field of material Bₛₐₜ.

FIGS. 9A, 9B, 9C and 9D shows trapped magnetic flux in respect to Lenz' law when applied field decreases in accordance with Bean's model for a pulse magnetization.

FIG. 10 shows by illustration the field concentration principle and shows that superconducting plates having trapped a zero magnetic flux modify the flux lines distribution.

FIG. 11 shows the magnetic flux concentration effect through an experiment with the same current. Two superconducting plates B are placed on both sides of the axis, between the coils. A Hall probe represented by arrow C measures the flux density.

FIG. 12 shows the field concentration results of an experiment conducted at liquid nitrogen temperature with two copper coils and two Bi-2223 plates at room temperature and at 77K.

FIG. 13 shows two field coils that provide a radial field that does not depend on the angular position, as shown in the field solenoids.

FIG. 14 shows four superconducting hulk plates used to trap magnetic field and thus shape the flux lines.

FIG. 15 shows the elements placed lead to a inductor topology able to create torque by interacting with a rotating field as explained in the principle of magnetic poles generation.

FIG. 16 shows the use of superconducting plates that shape the flux lines and lead to a non-uniform distribution of the radial field able to interact with an armature's rotating field.

FIG. 17 shows the active elements of the system are two coils fed with opposite currents that create a radial magnetic field.

FIG. 18 shows a middle cross section of the system, wherein positioning of coils 1 and superconducting shields 2 indicates where the flux concentration 3 or magnetic lines have to go around the shields.

FIG. 19 shows the mode of operation leads to the ideal distribution of the magnetic field radial component or the ideal repartition of the field for a homo-polar behavior.

FIG. 20 shows a picture of the magnetic poles created in a homo-polar mode or the topology in accordance with the invention.

FIG. 21 shows that in studying the homo-polar operation mode through experimental validation, a system of ten Hall probes is used to measure the magnetic field repartition.

FIG. 22 shows the results of the homo-polar mode to create magnetic poles from a radial uniform field distribution.

FIG. 23 shows the first step of the multi-polar mode, including positioning of the coils 1 and superconducting shields 2.

FIG. 24 shows the superconducting plates cooled down under their critical temperature, and trapping the magnetic flux in their volume (indicated by the bold arrows) in the second step of the multi-polar mode.

FIG. 25 shows the third step of the multi-polar mode where the current in the field coils is ramped down to zero; the superconducting plates stay cold and keep the trapped flux; and the superconducting plates now behave as permanent magnets.

FIG. 26 shows the fourth and last step of the multi-polar mode where the field coils are fed with an opposite current so that they can provide magnetic poles opposite to the ones trapped in the superconducting plates.

FIG. 27 shows the ideal shape of the magnetic field or ideal flux density provided in the multi-polar mode.

FIG. 28 shows the active length of the system is the length on which electro-magnetic torque is created as the useful length.

FIG. 29 shows addition of a third field coil to provide a magnetic field as the first step for the two-pattern topology and the arrows represent the field direction.

FIG. 30 shows the addition of a second set of superconducting plates to repeat the same pattern and that, in order to match the magnetic poles and to provide a coherent field, the superconducting plates have to be placed as shown in the two-pattern topology, and they have to be rotated by π/4 radians with respect to the first plates and then trap the opposite magnetic pole.

FIG. 31 shows that by using two patterns, the ratio of active length over total length is increased and then there is an increase in the potential torque density of the system, to provide a useful length for the two-pattern topology.

FIG. 32 shows there is no need to use larger superconducting shields to increase the length of the system, and that it is only necessary to add one elementary pattern in the multi-pattern inductor.

FIG. 33 shows electromagnetic characteristic of MgB2 wire used for the feasibility study. The straight line is the simplified characteristic considered a reasonable approximation to 25K behavior.

FIG. 34 shows a system wherein the coils have the dimensions, with L being the length, Rₑₓₜ the external radius, e the thickness of the winding, and d the distance between the two coils.

FIGS. 35, 36, and 37 show the whole system at room temperature, and the three phases of the inductor cooling phase.

FIG. 38 shows the superconductor motor embedded into a propeller.

FIG. 39 shows a diagram of the machine, showing Stator iron yoke 10. Stator windings 11, EM shield 12, HTS pancakes, 13 and HTS plates 14 on the right side, and Shaft 15, Bearings 16, and Housing 17 on the left side.

FIG. 40 shows the flux density distribution in a quarter if the inductor is in a plane following the surface of the plates.

FIG. 41 shows the flux distribution along the axis of the inductor, where it can be seen that the distribution of the field is far from being uniform; and the torque has been calculated using the average flux density.

FIG. 42 shows the radial distribution of the flux density in the air gap is regular, and the magnitude of the field can be different for north poles and south poles; due to faster decrease of the field stemming from the trapped flux.

### DETAILED DESCRIPTION OF PREFERRED EMBODIMENT OF THE INVENTION

Development of all-electric transportation systems requires an increase in power density of electrical systems, and while electric motors can be used for propulsion as well as for actuation, the power density of motors with conventional topologies is quite low due to the use of an iron core and the low current density of copper wires. And, since superconducting materials have undergone improvements in the last few years this should allow their use at practical temperatures. Therefore, superconductivity is most likely the technology that will lift these limitations and enable all-electric transportation systems. However, conventional superconducting motors are still limited by the use of iron core for small size motors, or by the lack of space needed to wind the field coils.

The invention provides a non-conventional topology for a superconducting inductor to be used in a synchronous machine using the unique capability of high temperature superconductors to trap magnetic field, and uses this phenomena coupled to field coils to provide a high magnetic field leading to a considerable increase in the power density.

### Flux Trapping in Bulk Superconductors

Low temperature superconductors are usually made of metallic components, and these materials are very sensitive to external magnetic field and exhibit magneto-thermal instabilities such as “flux jumps”. Moreover, their very low operating temperature, around 4K, disables their use in flux trapping applications. The discovery of high temperature superconducting ceramics allowed the consideration of “permanent magnet” utilization of superconductors. For example, YBCO or yttrium barium copper oxide (YBa₂Cu₃O₇), for instance, starts experiencing flux jumps below 10K under a very high magnetic field around 7 T and is therefore a material that can trap a large amount of flux and then be used in applications such as bearings. Up to now, 14 T is the highest value measured on top of a 24 mm YBCO disk at 30K.

### Principle of Flux Trapping/Magnetic Shielding

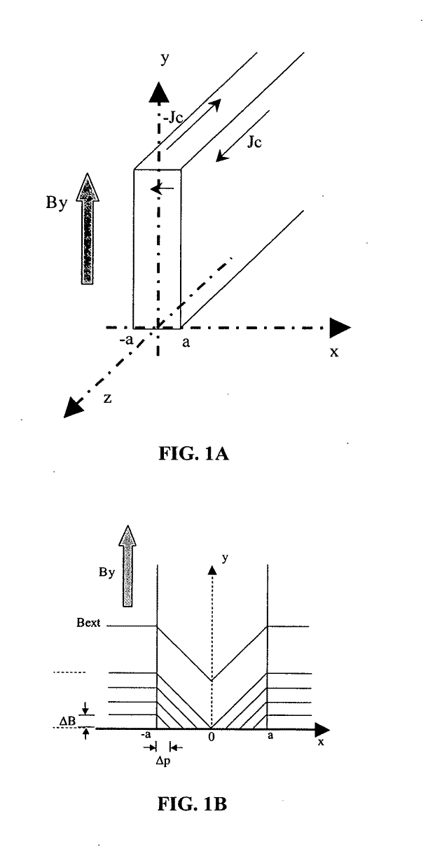

Magnetic flux trapping can make bulk superconductors behave as magnetic shields when zero field cooled (ZFC) or permanent magnets when field cooled (FC). These behaviors can be well-described using Bean's model, which is a phenomenological model, which states that the current density can only take three values in a superconducting material: +j_{c}, −j_{c} or 0. This model is able to predict the field distribution in a superconducting element. For example, if one considers an infinite superconducting plate undergoing an increase of applied flux density along the y-axis, it can be illustrated in FIGS. 1A and 1B.

FIG. 1A represents an infinite superconducting plate subjected to a longitudinal magnetic field in which currents develop in response to the increase of applied field.

FIG. 1B represents the magnetic field profile in the plate.

For an applied field increase of ΔB the flux in the material remains unchanged except in regions of thickness Δp in which the field penetrates, these areas are the places where current is induced. It is clear that the field profile in the material depends on the conditions under which the superconductor is cooled. Hereafter is described three different types of flux trapping.

### Zero Field Cooling (ZFC)

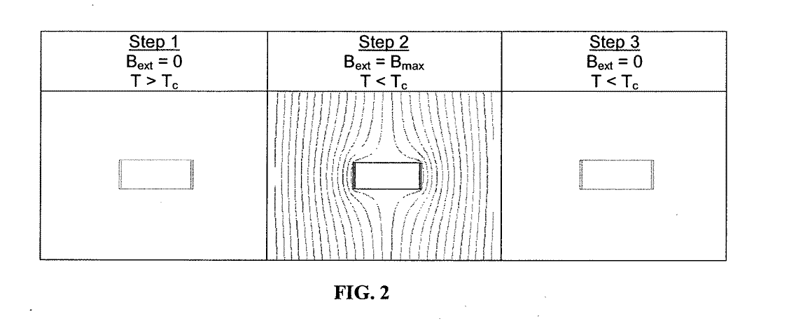

Consider a superconducting plate cooled under a null magnetic field. According to Lenz's law, a zero magnetic flux is trapped in the material, and then, the plate behaves as a magnetic shield shown in FIG. 2, which shows the three steps in zero field cooling by a superconducting plate.

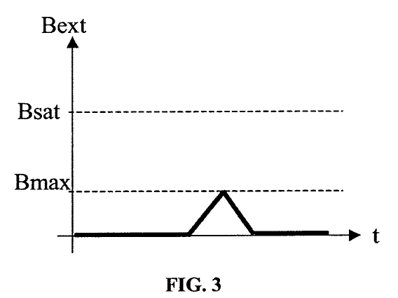

This magnetic shielding behavior can be explained by Bean's model, as shown in the following figures. In the applied field profile of FIG. 3, let us define Bₛₐₜ as the magnitude of the applied flux density that leads to a complete current saturation of the superconducting material. Bₘₐₓ is the maximum value of the magnitude of the applied flux density Bₑₓₜ.

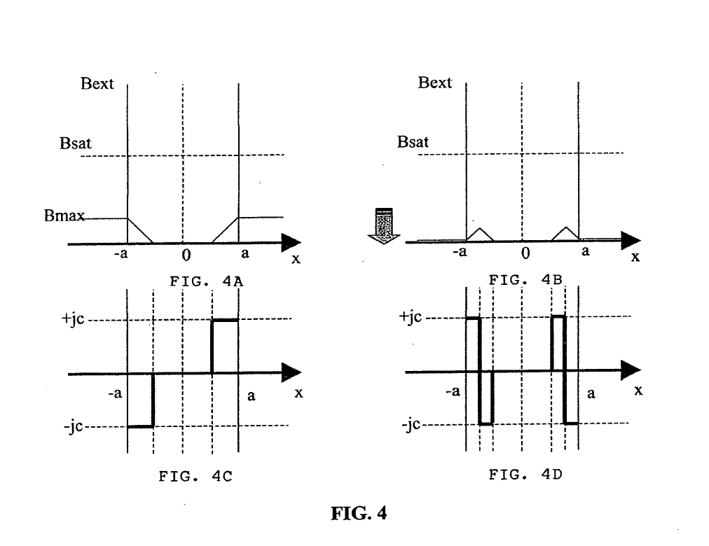

For a shielding operation, Bₘₐₓ has to be lower than Bₛₐₜ, and, the larger the difference, the better the shielding, as Bean's model for a zero field cooling in FIGS. 4A, B, C and D shows.

When the value of the applied field increases, currents are created in the material keeping most of its flux constant. However, the magnetic field can penetrate the areas where the currents are flowing. After a cycle of applied field, a residual flux is trapped in the material due to the non-damped induced currents.

### Field Cooling (FC)

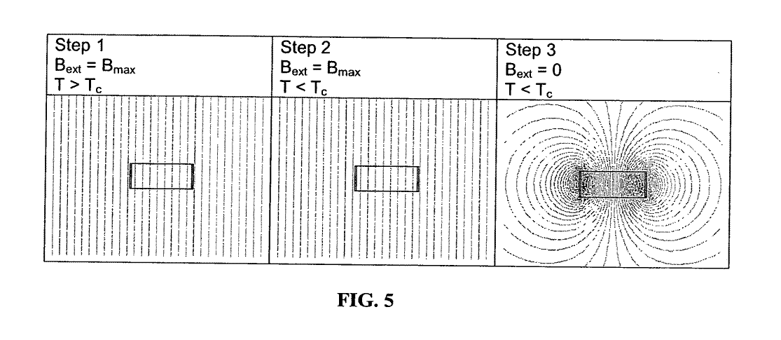

Field cooling is the most efficient way to trap magnetic flux in a superconducting material. After a field cooling, a superconducting plate behaves like a permanent magnet, as shown in the three steps of FIG. 5.

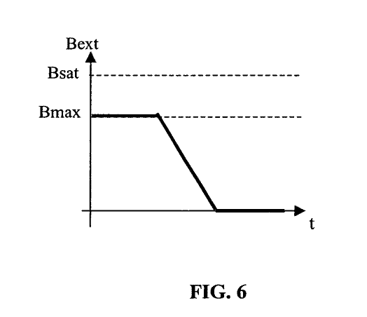

When one considers an applied magnetic flux profile as follows, the superconducting plate having been cooled under Bₘₐₓ, the applied field profile is shown in FIG. 6.

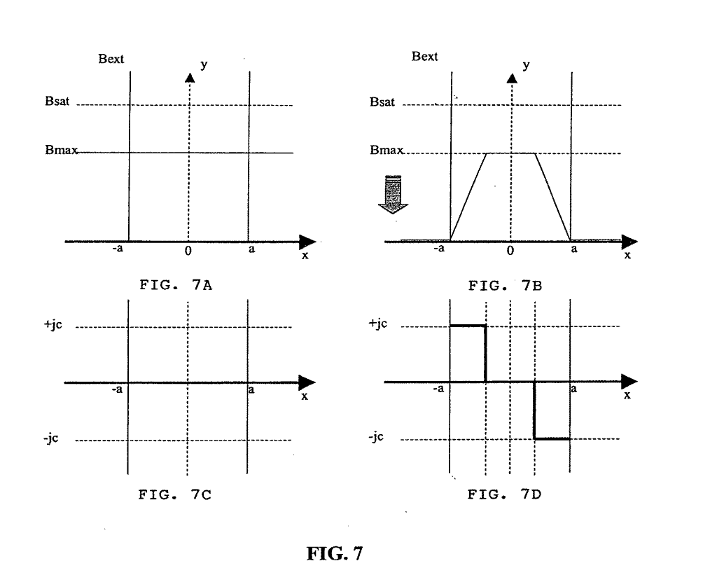

The critical state model for field cooling in FIGS. 7A, B, C, and D shows that a large part of the flux has been trapped. The trapped field decreases in the areas where current is flowing.

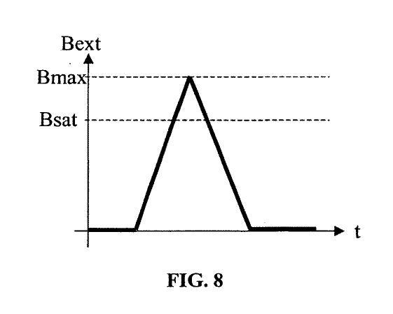

If one does not have a device able to provide a large value of magnetic field, a magnetic field pulse can then be used to magnetize the material. The peak value has to exceed the saturation field of the material Bₛₐₜ. The pulse can be depicted as shown in the applied field profile shown in FIG. 8.

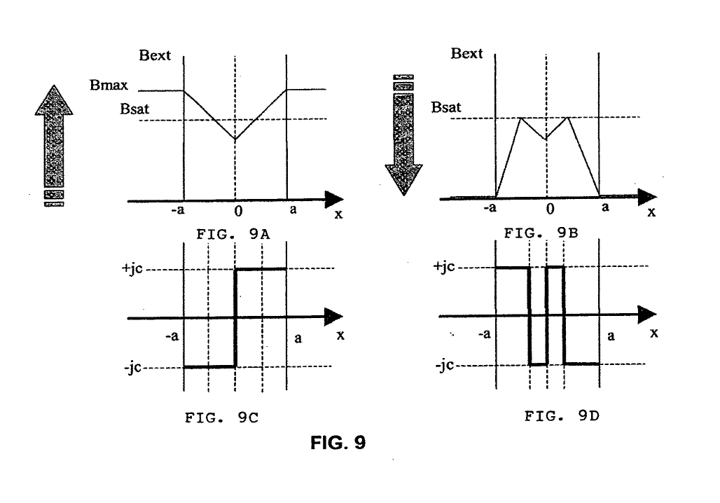

Once current has saturated the material, the magnetic field penetrates it and creates a magnetic flux. The latter is trapped in respect to Lenz' law when the applied field decreases, as depicted in FIGS. 9A,B,C and D in accordance with Bean's model for a pulse magnetization.

In general, this method provides inferior efficiency when compared to field cooling technique.

### Material Properties

While information is numerous on the topic of flux trapping in bulk high temperature superconductors, in today's environment, two materials can be used in a trapped field application. The bulk material exhibiting the highest current density is single domain YBCO. Its critical temperature is around 90K allowing its use at liquid nitrogen temperature. At 77K, this material can trap about 1.3 T and more than 6 T below 50K. Magnesium diboride, if used under 20K, can also be used to trap magnetic flux; however, unfortunately, this material suffers from magneto-thermal instabilities at low temperatures. Some measurements report a trapped field exceeding 1.5 Tesla below 15K, however, we have found that measured current densities in this material predict much higher trapping capabilities. Therefore, while Magnesium diboride (MgB₂) is an alternative, and will work in the context of the invention, it is not the best.

### Limitations and Considerations

Superconducting materials are sensible to the temperature and to applied magnetic field. The two principal manifestations of these sensibilities are the flux creep effect and the decrease in current density with a variable applied field.

### a) Flux Creep

High temperature superconductors operate at high temperature, in comparison to low temperature superconductors. Their operating temperature is usually between 30 and 77K. At these temperatures, thermal activation in the material is considerable. This thermal activation makes some vortexes move and thus create local losses that cause a current density decrease. From an external view, the magnitude of the trapped flux decreases with time. Several methods exist to offset this effect such as a relaxation method that consists in trapping the flux at a higher temperature and then decreasing the temperature.

Variable Field

Trapped flux can be altered by losses created by a variation of the applied magnetic field. However, one can diminish induced losses by lowering the operating temperature but usually the use of electromagnetic shields can eliminate this effect.

Flux Concentration with Superconducting Shields Principle of Flux Concentration

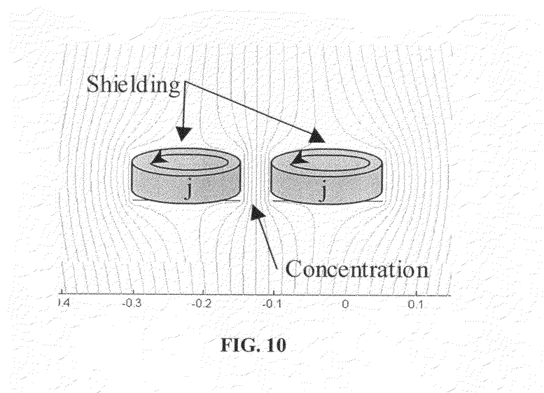

Since magnetic flux in superconducting plates remains constant, the latter cannot be modified by an external applied magnetic field. Thus, the applied field flux lines are distorted. FIG. 10 illustrates the field concentration principle and shows that superconducting plates having trapped a zero magnetic flux modify the flux lines distribution. Flux lines cannot penetrate the plates and have to go around them; thus, flux density is increased between the two plates.

### Experiments and “Concentration Factor”

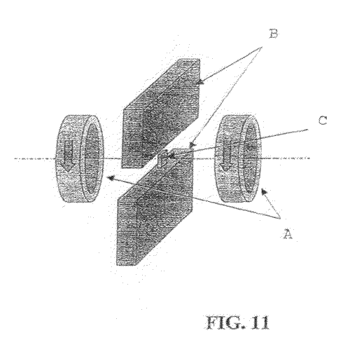

The magnetic flux concentration effect is shown through an experiment as exemplified in FIG. 11. Thus, two coils A (Helmoltz's coils) having the same axis are fed with the same current. Two superconducting plates B are placed on both sides of the axis, between the coils. A Hall probe represented by arrow C measures the flux density.

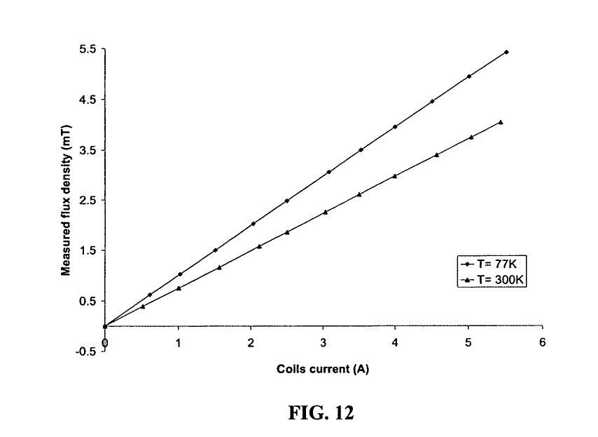

This experiment is conducted at liquid nitrogen temperature with two copper coils and two Bi-2223 plates. The experimental procedure consists of plotting the measured field versus the current in the coils at room temperature and at 77K. The field concentration results are depicted in FIG. 12.

The results show an increase of about 30% in the measured flux density between the room temperature and the liquid nitrogen temperature experiment. The magnetic field has actually been concentrated between the superconducting plates. Therefore, the concentration factor can be defined as the ratio between the measured flux density at 77K and its value at room temperature at the same current, as follows:

$$\frac{{B}_{77 K}}{{B}_{300 K}} = 1.3$$

The concentration factor is therefore a function of the shape and size of the superconducting plates.

### Concept for a New Superconducting Inductor

The ability of superconductors to trap magnetic field allows the distortion of flux lines and thus, flux density concentration. Earlier is a description of the mechanism of flux trapping as well as an experimental validation of magnetic field concentration. Presented hereafter is a non-conventional topology of inductor using this phenomenon to provide a multi-polar magnetic field with magnitude exceeding iron saturation. The disclosed topology is based on the superconductors' properties and is not doable using another technology.

### Superconducting Inductor Topology

Components

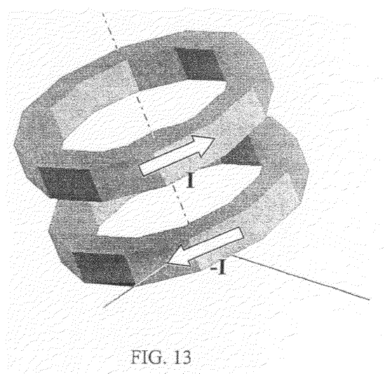

This inductor consists in a topology in which field solenoids and bulk superconducting plates are arranged as shown in FIGS. 13, 14, 15 and 16.

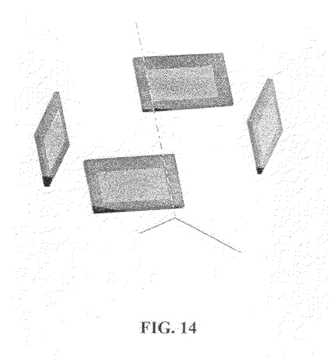

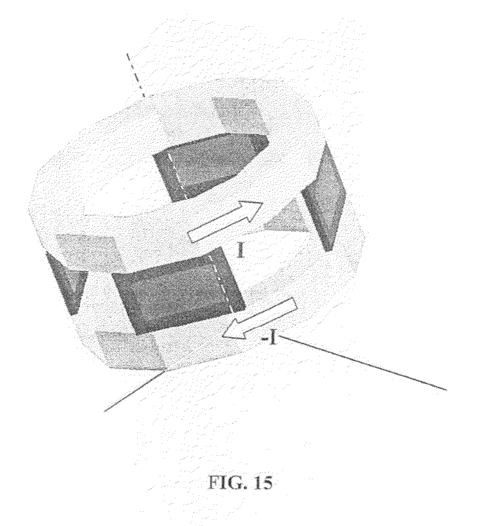

Two field coils provide a radial field that does not depend on the angular position, as shown in the field solenoids in FIG. 13.
Four superconducting bulk plates as shown in FIG. 14 are used to trap magnetic field and thus shape the flux lines.
These elements placed as shown in FIG. 15 lead to a inductor topology able to create torque by interacting with a rotating field as explained in the principle of magnetic poles generation.

### Principle of Magnetic Poles Generation

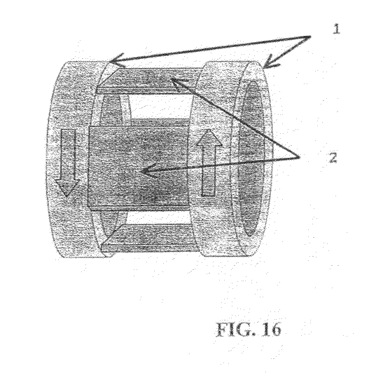

The two coils provide a radial field that does not depend on the radial position around their axis. In order to create torque by interacting with a rotating field, the inductor has to provide a spatial magnetic field variation. The use of superconducting plates will shape the flux lines and thus lead to a non-uniform distribution of the radial field able to interact with an armature's rotating field, as depicted in FIG. 16, which shows positioning of opposite field coils 1 with superconducting shields 2.

### Homo-Polar Behavior

Principle

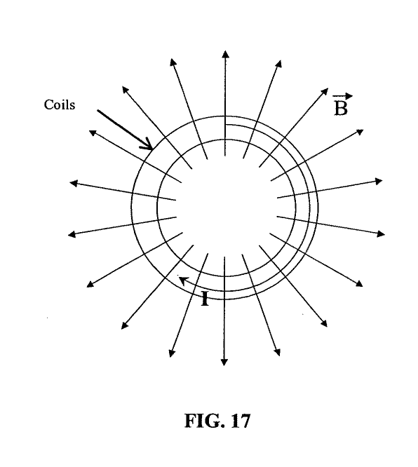

The active elements of the system are two coils fed with opposite currents. They create a radial magnetic field as shown in FIG. 17. This field does not depend on the angular position. This field distribution is not able to provide torque when placed in the rotating field of a motor armature. Therefore, we use bulk high superconducting material to shape the flux line and create a field distribution that depends on the angular position.

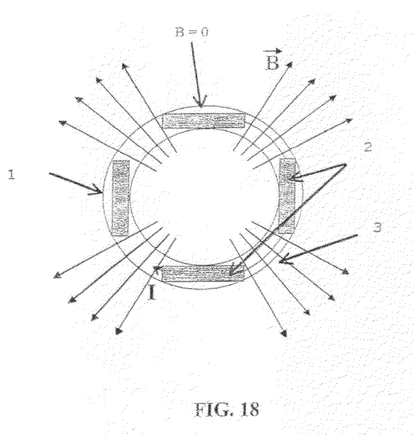

The first possible behavior leads to a homo-polar field distribution or behavior wherein the superconducting plates are cooled under a zero magnetic field and then act as magnetic shields. FIG. 18 shows a middle cross section of the system, wherein positioning of coils 1 and superconducting shields 2 indicates where the flux concentration 3 or magnetic lines have to go around the shields.

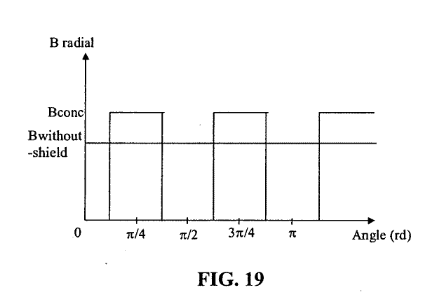

This mode of operation leads to the ideal distribution of the magnetic field radial component as shown in FIG. 19 or the ideal repartition of the field for a homo-polar behavior. The shaped field magnitude B_{cone} is different from the field provided by the coils B_{without-shield}. The superconducting magnetic shields have led to a concentration of the flux lines and then an increase of the field magnitude.

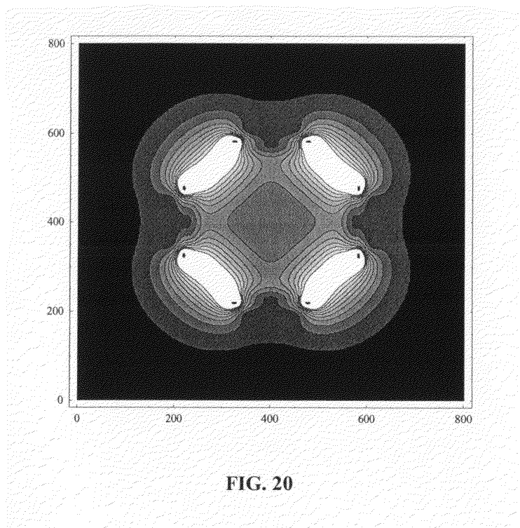

The picture in FIG. 20 shows the magnetic poles created in the homo-polar mode or the topology in accordance with the invention.

### Experimental Validation

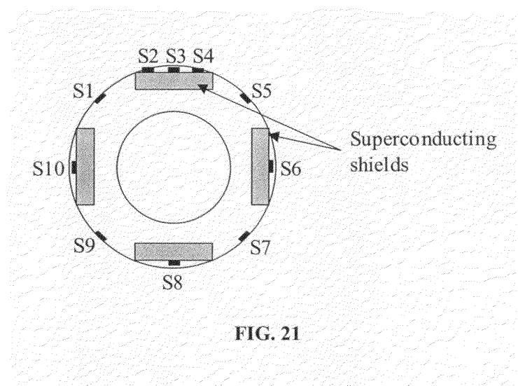

In studying the homo-polar operation mode through a experimental validation, we used a system depicted in FIG. 21 of ten Hall probes to measure the magnetic field repartition. These probes are named S1 to S10.

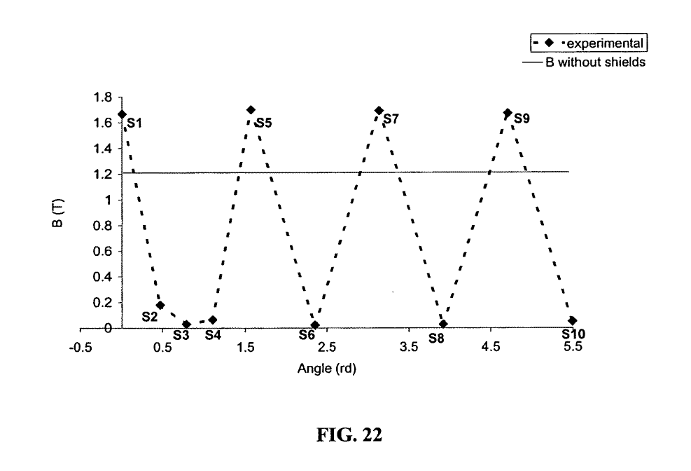

The experimental system, shows the results of the homo-polar mode as demonstrated in FIG. 22, to create magnetic poles from a radial uniform field distribution. From a flux density magnitude of 1.2 T created by the coils, we have obtained an angular variation in flux density from 0.01 T to 1.7 T.

This experiment shows a concentration factor of about 1.4 for the flux density. The inductor in this operation mode creates torque if used with a motor armature. However, its homo-polar behavior brings some magnetic interaction problems that would not allow the use of a conventional armature.

### Multi-Polar Behavior

In order to increase the torque density, we create a multi-pole behavior with the same topology. The cooling has to be different.
First, only the field coils have to be cooled and, once at the right temperature, are fed with the nominal current. Thus, they provide a radial field that penetrates the superconducting plates that are still in the normal state.

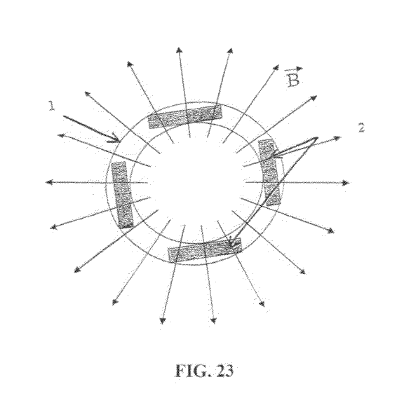

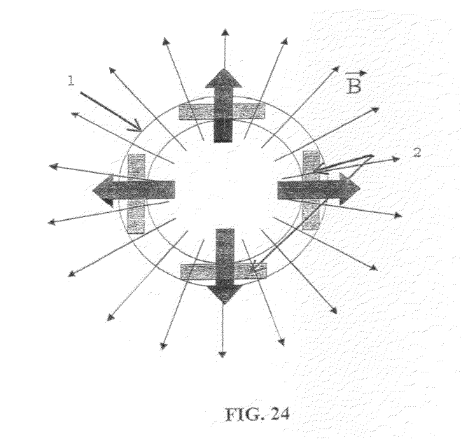

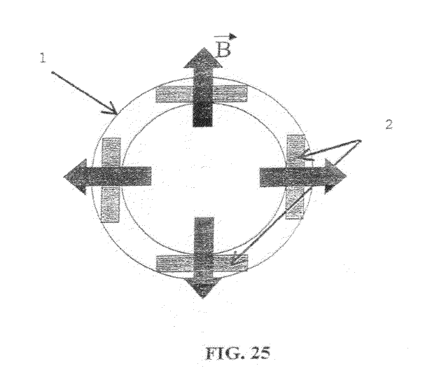

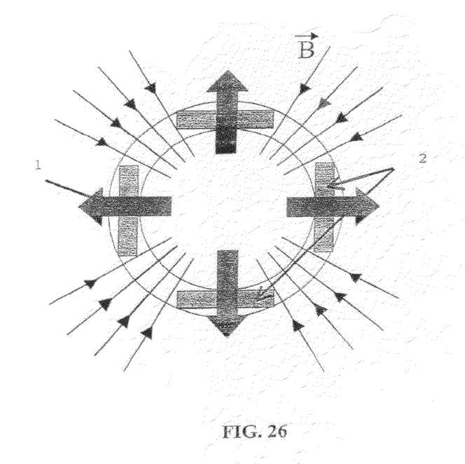

FIG. 23 shows the first step of the multi-polar mode, including positioning of the coils 1 and superconducting shields 2.
The superconducting plates are cooled down under their critical temperature, thus trapping the magnetic flux in their volume (as indicated by the bold arrows) as shown in FIG. 24 or the second step of the multi-polar mode.
In the third step of the multi-polar mode, as depicted in FIG. 25, the current in the field coils is ramped down to zero; the superconducting plates stay cold and keep the trapped flux; and the superconducting plates now behave as permanent magnets.
In the fourth and last step of the multi-polar mode, as shown in FIG. 26, the field coils are fed with an opposite current so that they can provide magnetic poles opposite to the ones trapped in the superconducting plates.
According to Lenz' law, flux in the superconducting plates stays almost unchanged.

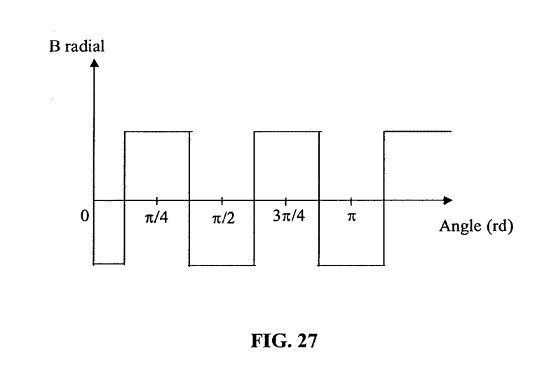

In that state, the inductor provides a radial flux variation with a null mean value. This field distribution can provide magnetic torque when used with a conventional armature and is much more efficient than the homo-polar version since the magnitude from peak to peak can be doubled with the exact same topology. FIG. 27 shows the ideal shape of the magnetic field or ideal flux density provided in the multi-polar mode.

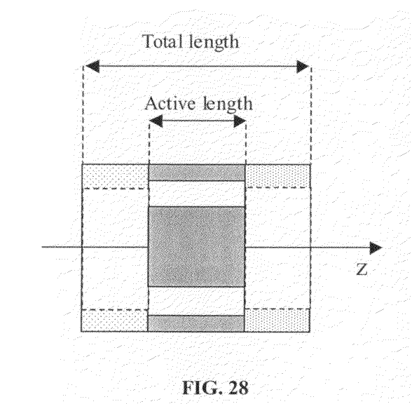

This topology is able to provide a very high inductor field to be used is electrical motors, however, the torque magnitude depends on the length on which the field is created. The active length for our system is the length on which electro-magnetic torque is created. This is the definition of the useful length, as depicted in FIG. 28.

It can be seen that the ratio of active length over total length is important. Part of the design consists in maximizing this ratio: the higher the ratio, the higher the torque density. In order to increase this ratio and show the real capabilities of this design, the multi-pattern topology has to be considered.

### Multi-Pattern Concept

### Multi-Pattern Topology

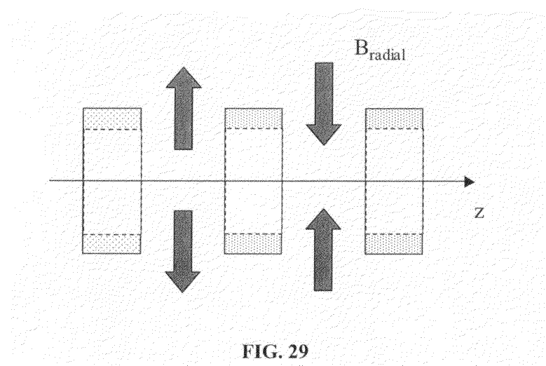

Considering the system presented earlier, we add a third field coil to provide a magnetic field, as shown in FIG. 29, which depicts the first step for the two-pattern topology. The arrows represent the field direction.

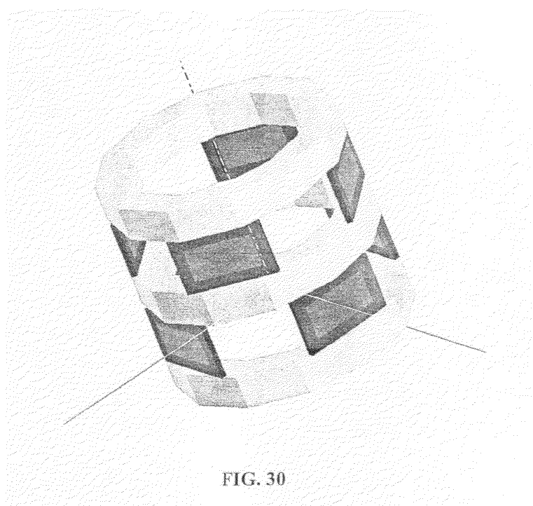

We then add four superconducting plates to repeat the same pattern as before. In order to match the magnetic poles and to provide a coherent field, the superconducting plates have to be placed as shown in the two-pattern topology shown in the rotor of FIG. 30. They have to be rotated by π/4 radians with respect to the first plates and then trap an opposite magnetic pole.

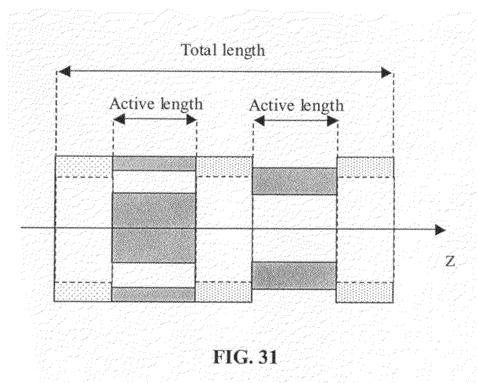

By using two patterns, we have increased the ratio of active length over total length and then increased the potential torque density of the system, as can be see in the useful length for the two-pattern topology shown in FIG. 31.

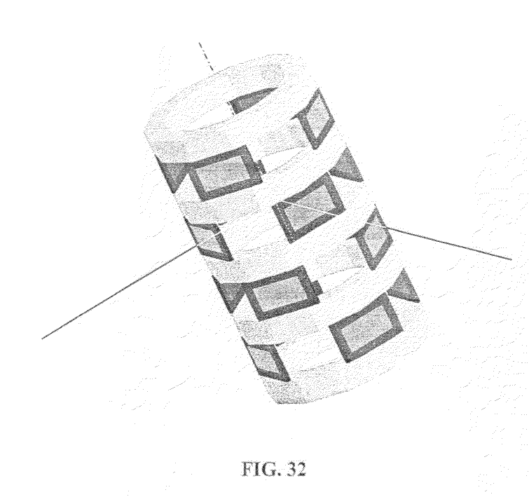

We can then create as many patterns as we need. One of the great advantages brought by this topology is that we do not need to use larger superconducting shields when we want to increase the length of the system. We just have to add one elementary pattern, as shown in the multi-pattern inductor in FIG. 32.

This system does not need an iron core and can be built with fiberglass. Thus, it is very light and allows very high power density.

Feasibility Study

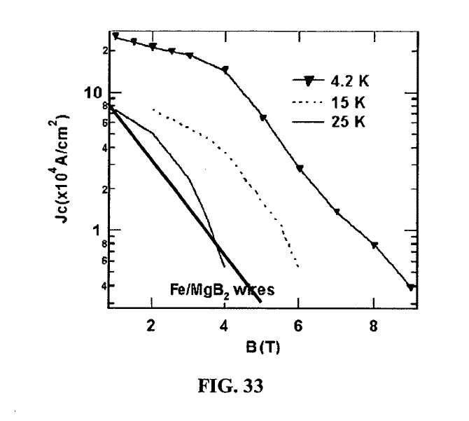

To compare this inductor design with conventional ones, we present an example of design showing a quantification of its expected performances. Let us consider that the field coils are made with magnesium diboride (MgB₂) wires with characteristics presented in FIG. 33. The straight line is the simplified characteristic we have considered (reasonable approximation to 25K behavior).

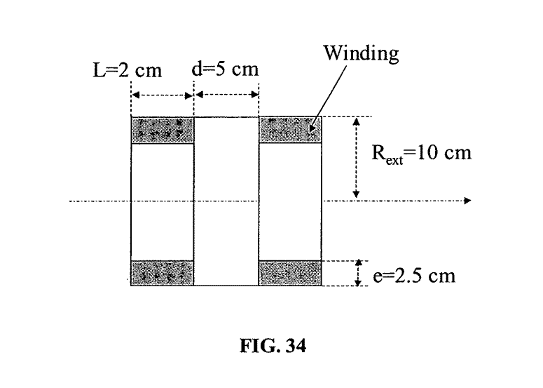

The coils have the following dimensions, with L being the length, Rₑₓₜ the external radius, e the thickness of the winding, and d the distance between the two coils, as depicted in the size of the studied system in FIG. 34 (and also the length of the superconducting plates).

These coils provide a radial flux density at the place where the superconducting plates will be of about 2.5 T.

The wire operating point corresponds to a current density in the wire of about 7.2*10⁸ A/m² and to a maximum flux density on the wire of 5.5 T.

To keep a safety margin, we worked at 2 T at the plates.

The superconducting plates have then to trap 2 T and to shield −2 T. The induced current will have to generate the equivalent of 4 T. This number is realistic when we consider single domain YBCO plates. Since this material is able to trap more than 10 T at 30K, we notice that, at 4 T, the material is still far from saturation.

A conventional inductor of a synchronous motor provide a field variation from −1 T to 1 T, the electromagnetic torque is directly proportional to this value.

Even though the design presented is far from the limitations of the material, it is still able to generate twice the field of a conventional inductor, and thus four times the torque density.

This illustrates the tremendous potential for increasing torque (power) density in electric motors by using the invention topology.

### Cooling Procedure

The cooling procedure is important for the operation of this system, and we need to cool down the coils and the bulk plates in a certain sequence. The coils may be cooled using liquid neon so that their temperature is perfectly controlled to allow the superconducting plates to be cooled by conduction. Other cooling sequence schemes will also work. To eliminate the flux creep phenomena in the bulk material, the field may be trapped at a temperature higher than the operating temperature.

### Cooling Sequence:

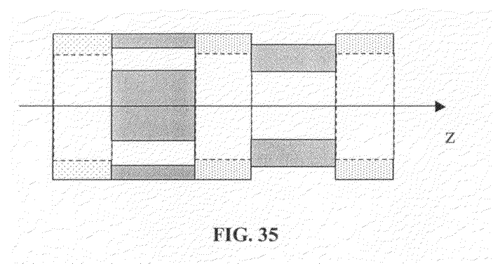

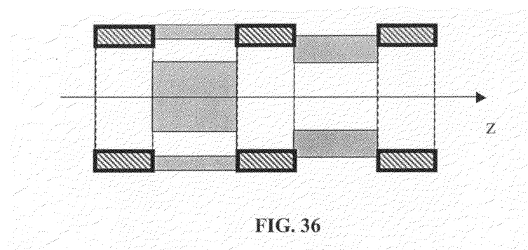

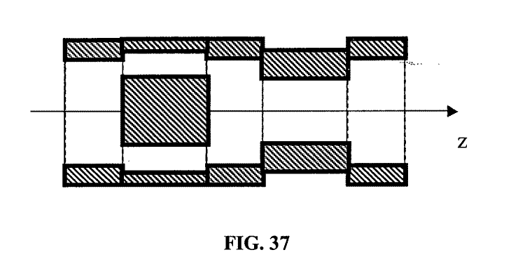

1. The whole system is at room temperature, and the three phases of the inductor cooling phase is shown in FIGS. 35, 36, and 37.
2. The field coils are cooled down; HTS plates have to stay above their critical temperature. The temperature control of the HTS plate may be achieved by using heaters.

Then, the nominal current is ramped up in the field coils.
3. The HTS plates are cooled down, and once the HTS plates are cooled down, the current is inversed in the field coils. At this point, the inductor provides a bi-polar magnetic field and is ready to be used.

The inventions system is a revolutionary topology for a superconducting inductor that provides at least twice the magnetic field of a conventional inductor. The topology is simple and consists of field coils with solenoid shapes and bulk superconducting plates. The invention's inductor does not need any iron core and is therefore very light, thus increasing the power density.

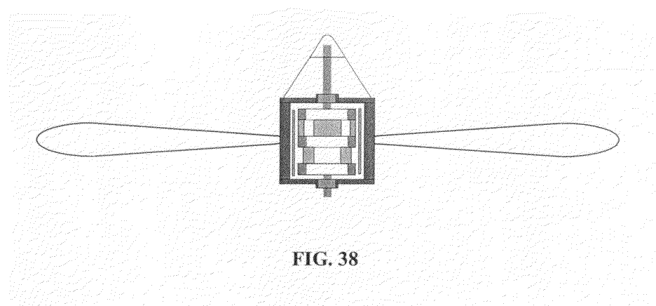

A configuration of the superconducting motor of the invention designed for use in aircraft propulsion is directed to a four-seat general aviation aircraft that requires about 200 HP of propulsion power. The design leads to a motor small enough to be embedded into the propeller to drive at 2700 RPM as shown in FIG. 38. The superconducting inductor is then fixed while the armature is mechanically connected to the propeller. This way, the cryogenic part does not have to move thus decreasing the losses.

This configuration is non conventional and is based on the outstanding properties of high temperature superconductors of the invention, both in bulk and wire forms.

### Motor Configuration

The developed configuration of synchronous motor uses currently available materials and exhibits high power density by increasing the air gap flux density when compared to conventional motors.

Our design has been done to fulfill the requirements of a Cessna 172 type aircraft for public use.

### Propulsion Requirements

The Cessna 172 is a four-seat aircraft driven by a propeller rotating at 2700 RPM. The conventional combustion engine develops 160 HP and weighs about 160 kg. The

TABLE I
DESIGN RESULTS

| | | |
|---|---|---|
| Total length | 160 | mm |
| External diameter | 220 | mm |
| Number of poles | 8 | |
| No-load average flux density | 1.3 | T |
| Electric loading | 300 | kA/m |
| EM Torque | 585 | Nm |
| Rotation speed | 2700 | RPM |
| Power | 220 | hp |
| Total mass (including conduction cooling apparatus) | 28 | kg |
| Power density | 3.6 | HP/lb |
| Heat load of superconducting pan | <10 | W |
| Operating temperature | 30 | K |

superconducting motor along with its cooling system needs to, at least, match these numbers.

### RESULTS

The designed inductor comprises two sets of superconducting plates and three coils. The coils are wound with Bi2223/Ag tapes operating at 30K with a filling ratio of 80%. The current is 80% of the critical current at to the wire operating point. The plates are in YBCO cooled at 30K and are theoretically able to trap more than 10 T. The geometry has been implemented in Maxwell3D from ANSOFT and optimized with the module Optimetrics.

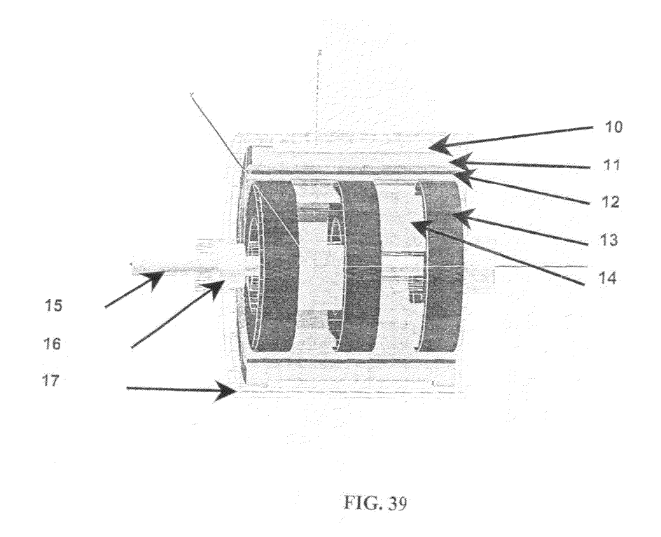

The results of the design are presented in Table I and in the FIG. 39 diagram of the machine, showing Stator iron yoke 10, Stator windings 11, EM shield 12, HTS pancakes, 13 and HTS plates 14 on the right side, and Shaft 15, Bearings 16, and Housing 17 on the left side.

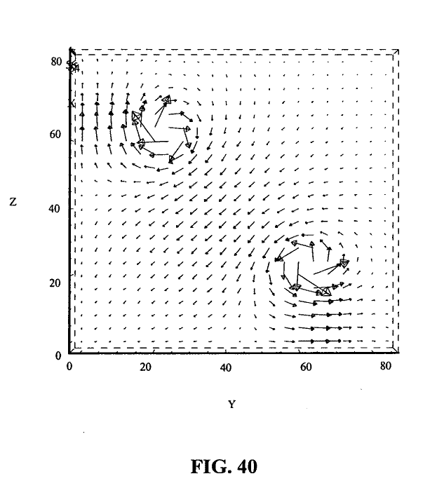

The total weight of the motor is 28 kg which includes the windings, the shields, the iron yoke and the conduction cooling apparatus FIG. 40 shows the flux density distribution in a quarter if the inductor in a plane following the surface of the plates. It is noticeable that the different magnetic poles provide a magnetic field that decreases differently in the air gap. The poles stemming from the field coils have a slower decrease than the one generated by the trapped flux.

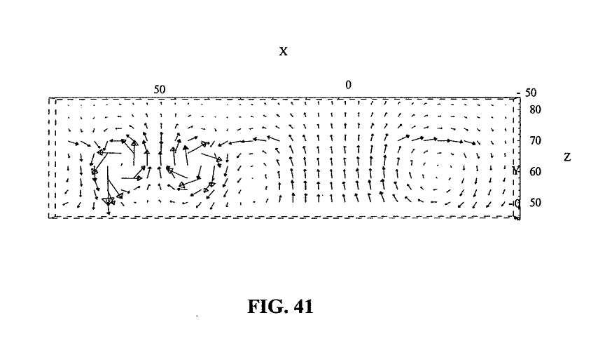

FIG. 41 shows the flux distribution along the axis of the inductor. We can see that the distribution of the field is far from being uniform; the torque has been calculated using the average flux density.

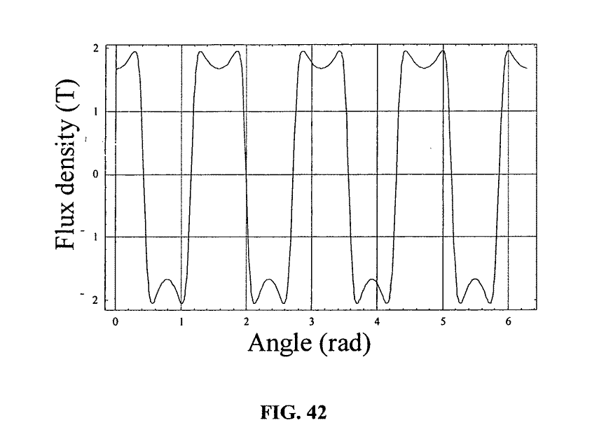

The radial distribution of the flux density in the air gap is regular as presented in FIG. 42, we can notice that the magnitude of the field can be different for north poles and south poles; this is due to faster decrease of the field stemming from the trapped flux.

We have designed a high temperature superconducting motor for aircraft propulsion. The unconventional configuration generates a very high power density by combining bulk material and wires, and thanks to a two-step cooling system. These very promising results show that the use of superconducting motors is possible in aircraft and could lead to a considerable increase of the payload as well as a tremendous decrease of the polluting emissions. The conventional engine of a Cessna 172 weighs 160 kg; our design provides a higher propulsion power with a weight of about 30 kg for the motor and roughly 60 kg for a non-optimized cryocooler.

We claim:

1. A method of operating a high temperature superconducting synchronous motor having a rotor positioned within a stator field and on which is disposed at least two polygon shaped ring or coil means along the same axis to provide separated and spaced apart relationship field solenoids, said motor having at least three high temperature superconducting plates disposed in alternating relationship to between said rings to hold said rings together to trap magnetic field and shape flux lines; comprising:
a) cooling the coils and ramping up the current prior to cooling the plates to obtain a field cooling;
b) cooling the plates to operating temperature under the field of the radial field; and
c) ramping down the current to zero and reversing same to generate a field in the opposite direction.

2. The method of claim 1, wherein the superconducting material of the plate means is a Yttrium-based compound.

3. The method of claim 2, wherein the Yttrium-based compound is YBCO.

4. The method of claim 3, wherein the YBCO is single domain YBCO.

5. The method of claim 1, wherein the superconducting material of the plate means is magnesium diboride.

6. The method of claim 1, wherein the ring or coil means are wound with Bi223/Ag tapes.

7. A high temperature superconducting synchronous motor having an inductor topology that increases the air gap flux density in direct relation to motor power density by trapping flux and concentrating it in the air gap to obtain more power in the same volume or smaller volume for the same power, and whose geometry enables said induction motor to be lighter than superconducting motors without said synchronous topology, said motor being positioned in a housing, and said motor comprising:
a) stator means having an armature winding to provide a stator field;
b) rotor means positioned within the stator field and on which is disposed an inductor of a topology comprising i) at least two polygon shaped ring or coil means along the same axis to provide separated and spaced apart relationship field solenoids; and
ii) at least three high temperature superconducting plate means disposed in alternating relationship between said ring or coil means to hold said ring or coil means together to trap magnetic field and shape flux lines; to improve power density; and
c) cooling means to cool said superconducting motor with rotor means to a temperature below the critical temperature of the superconducting plate means; wherein the polygon shaped ring or coil means is a regular octagon.

8. The high temperature superconducting synchronous motor of claim 7, further including an A/C drive connected to the stator means to generate a magnetic field around the rotor.

9. The high temperature superconducting inductor of claim 7, wherein the superconducting material of the plate means is a Yttrium-based compound.

10. The high temperature superconducting synchronous motor of claim 9, wherein the Yttrium-based compound is YBCO.

11. The high temperature superconducting synchronous motor of claim 10, wherein the YBCO is single domain YBCO.

12. The high temperature superconducting synchronous motor of claim 7, wherein the superconducting material of the plate means is magnesium diboride
